(19) United States
(12) Patent Application Publication
(10) Pub. No.: US 2026/0078019 A1
(43) Pub. Date: Mar. 19, 2026

(54) IN-FIELD ANTIMICROBIAL REGULATION AND VALIDATION SYSTEM FOR IRRIGATION SYSTEM

(71) Applicant: KiVAR Chemical Technologies, Bakersfield, CA (US)

(72) Inventors: Richard Varley, Bakersfield, CA (US); Kevin Varley, Bakersfield, CA (US)

(21) Appl. No.: 19/296,223

(22) Filed: Aug. 11, 2025

Related U.S. Application Data
(60) Provisional application No. 63/694,508, filed on Sep. 13, 2024.
(60) Provisional application No. 63/694,442, filed on Sep. 13, 2024.

(51) Int. Cl. C02F 1/00; C02F 1/72

(52) U.S. Cl. CPC C02F 1/008; C02F 1/722; C02F 2209/003; C02F 2209/36; C02F 2209/42; C02F 2305/023; C02F 2307/14

(57) ABSTRACT

Embodiments of the present invention provide systems and devices that can automatically apply an antimicrobial dose to irrigation water and monitor the antimicrobial residual of the water flowing downstream. The dose can be adjusted using one or more pumps to add additional antimicrobial dose as desired, for example, according to downstream measurements of water conditions, including for example, the level of antimicrobial agent or chemicals detected in the water. The amount of antimicrobial agent can be measured using an amperometric sensor or similar device that measures the electric current flowing between two electrodes, for example. According to some embodiments, remote sensors are placed at various locations of the irrigation system to measure and validate antimicrobial levels throughout the system. According to some embodiments, at least one dosing pump is controlled based on the flow rate of the irrigation water.

### CROSS-REFERENCE TO RELATED APPLICATIONS

This application claims the benefit of and priority to U.S. Provisional Patent Application No.63/694,508 filed on Sep. 13, 2024, and to U.S. Provisional Patent Application No. 63/694,442 filed on Sep. 13, 2024, the contents of which are hereby incorporated by reference in their entirety.

### FIELD

Embodiments of the present invention generally relate to the field of irrigation. More specifically, embodiments of the present invention relate to systems and methods for monitoring and controlling the content and conditions of water used by irrigation systems.

### BACKGROUND

Irrigation systems are commonly used in agriculture to supply fields with water and nutrients to support healthy crop growth. While these systems are often essential for large-scale crop production, they can be prone to microbial contamination, which can negatively impact crop health and poses a danger to consumers. Contaminated produce poses a significant danger to consumers and can lead to major illness and even death. For this reason, chemicals (e.g., antimicrobial agents) are added to the irrigation water supply to prevent out of control microbial growth. Peracetic acid (PAA) is one commonly used antimicrobial chemical. The use of these chemicals is also mandated by certain agreements such as the California Leafy Greens Marketing Agreement (CLGMA) and the Arizona Leafy Greens Marketing Agreement (ALGMA). However, the lack of real-time monitoring and precise regulation of dosing can lead to overuse or underuse of these chemicals, significantly impacting both the environment, crop yield, and food safety. Therefore, it is critically important to monitor the amount of antimicrobial agent present in the water supply and to verify that conditions fall within a specific range of acceptable values. Unfortunately, current systems are unable to sufficiently regulate and validate content and conditions of the irrigation water supply in real-time, especially at large scales. Therefore, modern irrigation systems typically require manually measuring the amount of antimicrobial agent present in the irrigation water using time consuming and laborious techniques that fail to scale adequately to address the needs of large-scale modern agricultural operations. These manual techniques typically involve an employee manually checking the water using a dipstick testing device to determine water content and conditions.

Moreover, modern irrigation systems often include a complex series of lengthy lines (e.g., pipes, irrigation channels, etc.) that can extend dozens of yards or even miles before reaching an outlet or sprinkler that releases the water into the field. In these cases, the conditions of water at different sections of an irrigation line may be very different with respect to concentration of antimicrobial agents. For example, when certain chemical additives are supplied to the irrigation water, the microbes present in the water may consume or otherwise deplete a significant portion of the additive such that the additive is greatly diminished before the water reaches an outlet. As such, it is presently difficult to monitor and adjust the additives used in irrigation systems to control microbial content in the entire water supply when accommodating different lines or line sections within a large-scale irrigation system in real-time.

For these reasons, an improved approach to automatic antimicrobial regulation and validation is desired.

### SUMMARY

Accordingly, embodiments of the present invention provide systems and devices that can automatically apply an antimicrobial dose to irrigation water and accurately monitor the antimicrobial residual of the water flowing downstream. The dose can be adjusted using one or more pumps to add additional antimicrobial dose as desired, for example, according to downstream measurements of water conditions, including for example, the amount of antimicrobial agent detected in the water. The amount of antimicrobial agent can be measured using an amperometric sensor or similar device that measures the electric current flowing between two electrodes, for example. According to some embodiments, remote sensors are placed at various locations of the irrigation system to accurately measure and validate antimicrobial levels throughout the system. According to some embodiments, at least one dosing pump is controlled based on the flow rate of the irrigation water.

According to one disclosed embodiment, an irrigation system is disclosed. The irrigation system includes a water line, a control unit comprising a network interface, a first dosing pump coupled to the water line, the dosing pump being operable to release an antimicrobial agent into water flowing through the water line, and a sensor coupled to the water line and operable to measure an antimicrobial residual of the water flowing through the water line. The sensor is disposed at a downstream location of the first dosing pump, and the control unit is operable to receive sensor data from the sensor indicating the antimicrobial residual at the downstream location via the network interface and transmit control signals to the first dosing pump to control a function of the first dosing pump based on the sensor data via the network interface.

According to some embodiments, the control unit is further operable to transmit control signals to the first dosing pump based on the sensor data to maintain the antimicrobial residual substantially within a predefined range.

According to some embodiments, the control unit is further operable to trigger an alarm when the antimicrobial residual measured by the sensor is not substantially within the predefined range.

According to some embodiments, the control unit is further operable to adjust the function of the first dosing pump when the antimicrobial residual measured by the sensor is not substantially within the predefined range.

According to some embodiments, the irrigation system includes a second dosing pump, and the control unit is further operable to adjust a function of the second dosing pump based on the sensor data.

According to some embodiments, the irrigation system includes a second dosing pump and a water meter coupled to the water line, and the control unit is further operable to receive a water flow rate indicated by the water meter via the network interface and adjust a function of the second dosing pump based on the water flow rate.

According to some embodiments, the irrigation system includes a first sprinkler coupled to the water line and operable to release water into a field, and the sensor is disposed downstream of the first dosing pump and upstream of the first sprinkler of the irrigation system.

According to some embodiments, the irrigation system includes a farthest downstream sprinkler coupled to the water line and operable to release water into a field, the sensor is disposed downstream of the first dosing pump and downstream of the farther downstream sprinkler, and the processor is further operable to validate an antimicrobial level of the irrigation system based on the sensor data.

According to some embodiments, the antimicrobial agent comprises peracetic acid (PAA), and the sensor comprises a PAA amperometric sensor.

According to some embodiments, the irrigation system includes a secondary water line coupled to the water line and a remote sensor coupled to the secondary water line at an intermediate point between a beginning of the secondary water line and an end of the secondary water line. The remote sensor is operable to measure the antimicrobial residual and transmit sensor data to the control unit.

According to some embodiments, the irrigation system includes a secondary water line coupled to the water line, and a remote sensor coupled to the secondary water line at an end of the secondary water line, and the remote sensor is operable to measure the antimicrobial residual at the intermediate point and transmit sensor data to the control unit.

According to another embodiment, an antimicrobial treatment system for treating irrigation water is disclosed. The antimicrobial treatment system includes a control unit operable to transmit control commands to a first dosing pump and a second dosing pump of an irrigation system, said first dosing pump operable to release a continuous dose of antimicrobial agent into the irrigation water at a given frequency, and said second dosing pump operable to release a periodic dose of antimicrobial agent into the irrigation water based on real-time sensor data.

According to some embodiments, the antimicrobial treatment system includes an amperometric sensor disposed at a downstream location of the first dosing pump and the second dosing pump and operable to measure an antimicrobial residual of the irrigation water at the downstream location The real-time sensor data is generated by the amperometric sensor.

According to some embodiments, the antimicrobial treatment system includes a water meter operable to measure a flow rate of the irrigation water, and the control unit is operable to control frequency of the first pump based on the flow rate.

According to some embodiments, the antimicrobial treatment system includes a liquid antimicrobial storage tank operable to supply the antimicrobial agent to the first dosing pump and the second dosing pump.

According to some embodiments, the antimicrobial treatment system includes a remote amperometric sensor disposed at a downstream location of the first dosing pump and the second dosing pump and operable to validate an antimicrobial residual of the irrigation water at an endpoint of a water line carrying the irrigation water.

According to a different embodiment, an apparatus for controlling an antimicrobial water treatment system of an irrigation system is disclosed. The apparatus includes a processor, a memory coupled to the processor operable to store data, and a processor operable to receive sensor data from an amperometric sensor operable to indicate an antimicrobial residual measured at the sensor, generate a control signal for controlling a dosing pump based on the sensor data, and transmit the control signal to the dosing pump to control a function of the dosing pump.

According to some embodiments, the amperometric sensor is disposed downstream of the dosing pump and at a location upstream of a first sprinkler of the irrigation system.

According to some embodiments, the amperometric sensor is disposed downstream of the dosing pump and at a location downstream of a last sprinkler of the irrigation system, and the processor is further operable to validate an antimicrobial level of the irrigation system based on the sensor data.

According to some embodiments, the antimicrobial agent comprises peracetic acid (PAA), and the amperometric sensor comprises a PAA amperometric sensor.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a diagram depicting an exemplary automatic antimicrobial treatment and validation system operable to treat an irrigation water supply to prevent uncontrolled microbial growth in-field according to embodiments of the present invention.

FIG. 2 is a diagram depicting an exemplary automatic antimicrobial treatment and validation system including a single dosing pump according to embodiments of the present invention.

FIG. 3 is a diagram depicting an exemplary automatic antimicrobial treatment and validation system including a two dosing pumps according to embodiments of the present invention.

FIG. 4 is a diagram depicting an exemplary automatic antimicrobial treatment and validation system including two dosing pumps and a water meter according to embodiments of the present invention.

FIG. 5 is a diagram depicting an exemplary remote sensor of an automatic antimicrobial treatment and validation system disposed at an intermediate point of a water line of an irrigation system according to embodiments of the present invention.

FIG. 6 is a diagram depicting an exemplary remote sensor of an automatic antimicrobial treatment and validation system disposed at the end of a water line according to embodiments of the present invention.

FIG. 7 is data flow diagram depicting an exemplary antimicrobial treatment system for controlling antimicrobial levels in an irrigation system according to embodiments of the present invention.

FIG. 8 is block diagram of an exemplary computer system platform upon which embodiments of the present invention can be implemented.

### DETAILED DESCRIPTION

Reference will now be made in detail to several embodiments. While the subject matter will be described in conjunction with the alternative embodiments, it will be understood that they are not intended to limit the claimed subject matter to these embodiments. On the contrary, the claimed subject matter is intended to cover alternative, modifications, and equivalents, which may be included within the spirit and scope of the claimed subject matter as defined by the appended claims.

Furthermore, in the following detailed description, numerous specific details are set forth in order to provide a thorough understanding of the claimed subject matter. However, it will be recognized by one skilled in the art that embodiments may be practiced without these specific details or with equivalents thereof. In other instances, well-known methods, procedures, components, and circuits have not been described in detail as not to unnecessarily obscure aspects and features of the subject matter.

Portions of the detailed description that follows are presented and discussed in terms of a method. Although steps and sequencing thereof are disclosed in a figure herein describing the operations of this method, such steps and sequencing are exemplary. Embodiments are well suited to performing various other steps or variations of the steps recited in the flowchart of the figure herein, and in a sequence other than that depicted and described herein.

Some portions of the detailed description are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer-executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout, discussions utilizing terms such as “accessing,” “writing,” “including,” “storing,” “transmitting,” “associating,” “identifying,” “encoding,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

### In-Field Antimicrobial Regulation and Validation System Including One or More Sensors

Embodiments of the present invention provide systems and devices that can automatically apply a dose of an antimicrobial chemical or agent to irrigation water and accurately monitor the antimicrobial residual of the water downstream. An antimicrobial agent can be supplied in controllable doses using one or more pumps, for example, according to downstream measurements indicating water conditions, such as the level of antimicrobial agents or chemicals detected in the water as the water flows downstream through an irrigation line, or at the very end of an irrigation line. This system ensures that adequate amounts of antimicrobial agent are present in all irrigation lines. The amount of antimicrobial agent in the water can be validated in real-time at various points of the irrigation system, which greatly improves the safety and reliability of the irrigation system and the agricultural product thereof. The level of antimicrobial agents can be measured using an amperometric sensor or similar device that measures the electric current flowing between two electrodes in real-time, for example. According to some embodiments, at least one dosing pump is controlled based on the flow rate of the irrigation water. The antimicrobial chemical can be peracetic acid (PAA), chlorine dioxide, chlorine (liquid or solid) without pH control, or chlorine with pH control, for example.

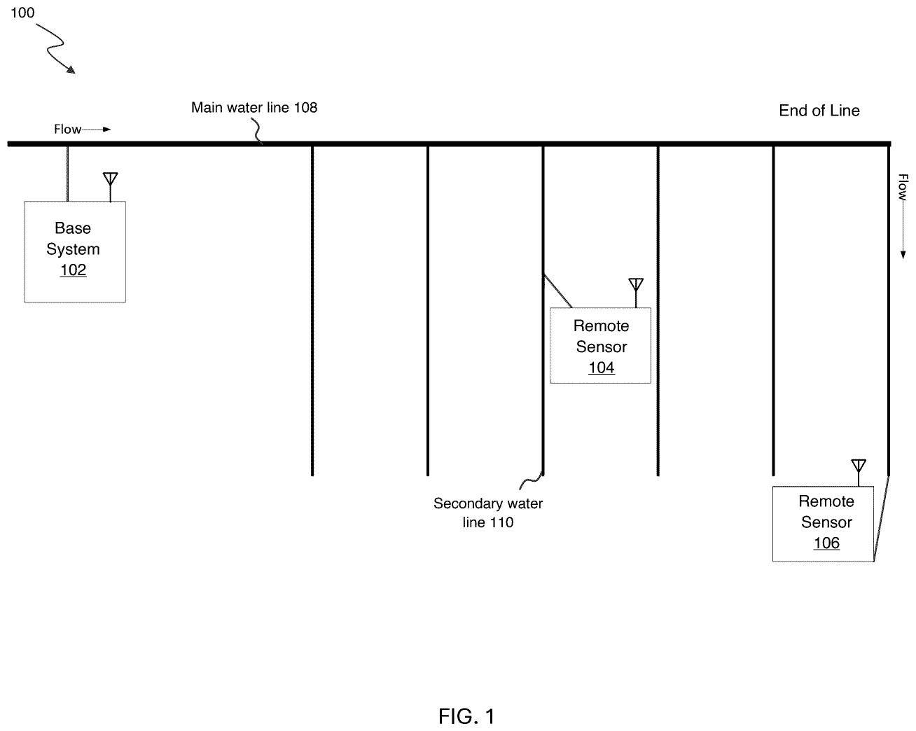

FIG. 1 is a diagram depicting an exemplary antimicrobial treatment system 100 for use with an irrigation system according to embodiments of the present invention.

Irrigation system 100 typically includes a main water line or open duct/canal and one or more branching water lines. Advantageously, antimicrobial treatment system 100 can automatically dose, monitor, and validate the treatment and condition of the irrigation water, including the real-time amount of antimicrobial agent present in the water supply at various locations throughout the irrigation system, including various lines, pipes, ducts, canals, etc. In this way, the amount of antimicrobial agent can be maintained within a desired limit in the irrigation system using automated techniques that can be scaled to accommodate the demands of large-scale modern agriculture.

Antimicrobial treatment system 100 typically includes a small container or tank that stores an antimicrobial agent and a dosing pump that applies a controlled dose of antimicrobial agent to the irrigation water. A sensor downstream from the dosing pump monitors the amount of antimicrobial agent present in the water. The dosing pump and the sensor are advantageously in communication (e.g., wireless communication) with a control unit that controls the dosing pump, for example, according to the reading of the sensor or according to the flow rate of the water line. The sensor can be an amperometric sensor in one embodiment such as PAA amperometric sensor, although any suitable sensor can be used.

In the example of FIG. 1, antimicrobial treatment system 100 includes a base treatment system 102 and two optional remote monitoring units 104, 106 disposed at different locations of the irrigation system to monitor the condition of the irrigation water carried by the irrigation lines. Remote monitoring unit 104 includes an intermediate sensor disposed roughly in the middle of the irrigation system on secondary water line 110, and remote monitoring unit 106 includes an end of line sensor disposed after the last sprinkler or outlet of the irrigation system 100. Remote monitoring unit 104 can also be disposed in the trunk line downstream of base system 102, although base system 102 can include its own sensor, according to embodiments. In this way, antimicrobial treatment system 100 can determine the extent to which antimicrobial agents added to the water of the main water line 108 at the base treatment system 102 are consumed or depleted at various points of the irrigation system in real-time. The antimicrobial agent can be peracetic acid, chlorine, or any other oxidant suitable for treating water applied to fields of leafy greens or other vegetation, for example.

Importantly, antimicrobial treatment system 100 can automatically adjust the amount of antimicrobial agent added to the irrigation water at any time based on the monitored results. For example, the amount of antimicrobial agent can be increased or decreased manually, or set to a specific range of values that is automatically maintained using one or more dosing pumps. Moreover, an alarm or other notification can be set to trigger any time the amount of antimicrobial agent in the irrigation water exceeds the pre-determined range, or reaches a predetermined value. The amount of antimicrobial agent in the water can be measured in ppm, for example. For conventionally grown produce, the desired ppm of PAA may be around 10 ppm (e.g., within a range of 9.5 ppm and 10.5 ppm). For organically grown produce, the desired ppm of PAA may be around 5 ppm (e.g., within a range of 4.5 ppm and 5.5 ppm). The current dosage and measured ppm can be displayed on a display device of the control system, according to some embodiments. According to some embodiments, historic control and measurement data is stored and accumulated on a storage device (e.g., hard drive or memory) of the antimicrobial treatment system 100.

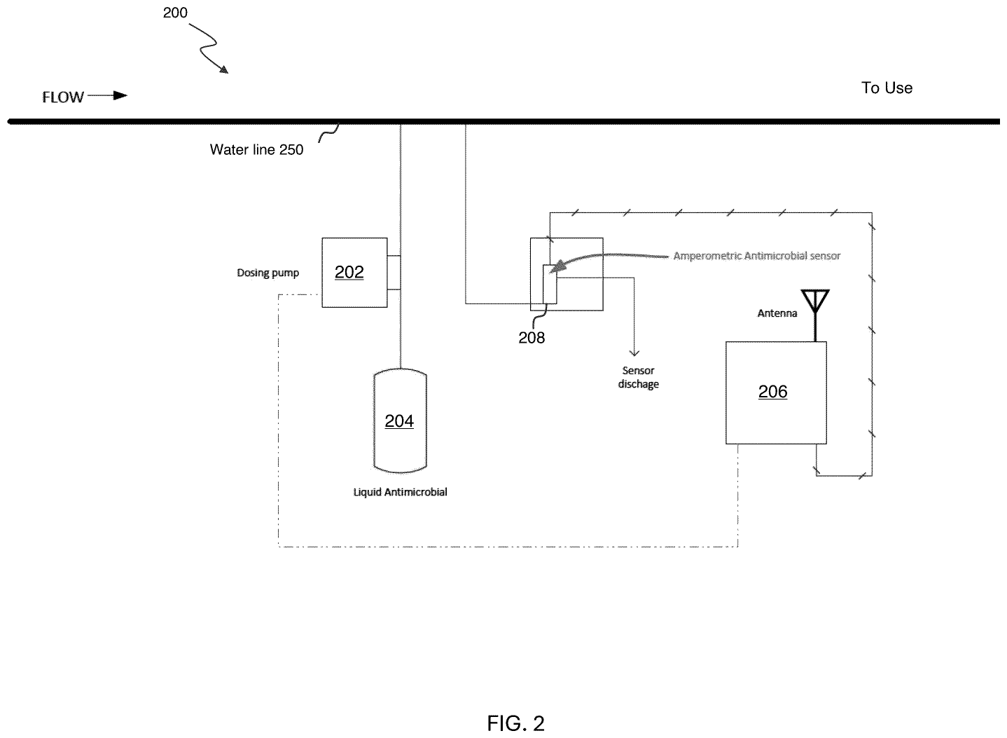

FIG. 2 is a diagram depicting an exemplary automatic antimicrobial treatment and validation system 200 including a single dosing pump 202 according to embodiments of the present invention, although additional dosing pumps may be used according to embodiments. Automatic antimicrobial treatment and validation system 200 is a base treatment station disposed near a main irrigation line 250. The operation of dosing pump 202 is controlled by control unit 206 to automatically release antimicrobial agents from liquid antimicrobial storage tank 204 into main irrigation line 250 to bring the level of antimicrobial agent in the water flowing through main irrigation line 250 to a specific level, or within a specific range of acceptable values. According to some embodiments, dosing pump 202 releases an antimicrobial agent in controlled doses according to a predetermined dosing schedule. The dosing schedule can be defined according to specific time intervals, time of day, and/or according to measurements taken by one or more antimicrobial sensors (e.g., amperometric sensor 208).

According to some embodiments, control unit 206 can control dosing pump 202 based on the measurements (e.g., real-time measurements) of one or more antimicrobial sensors in the irrigation system. In the example of FIG. 2, dosing pump 202 is controlled by control unit 206 based on the level of antimicrobial agent detected by amperometric sensor 208 coupled to water line 250 down stream of dosing pump 202. Therefore, amperometric sensor 208 indicates the amount of antimicrobial agent after the water has been treated and flowed through water line 250 for some distance (the antimicrobial residual). Accordingly, control unit 206 can cause dosing pump 202 to supply additional antimicrobial agent when the measured antimicrobial residual is below the desired level, and conversely can cause dosing pump 202 to supply less antimicrobial agent when the measured antimicrobial levels are above the desired level, for example. Moreover, the control unit 206 can turn off the dosing pump 202 when antimicrobial levels reach a predetermined level (maximum level), and the control unit 206 can turn the dosing pump 202 back on when antimicrobial levels return to another predetermined level. According to some embodiments, the range of acceptable values can be delineated withing a range of acceptable values, e.g., from 1-5, where 1 is the lowest acceptable value, 3 is considered an ideal value, and 5 is the highest acceptable value. Different triggers, commands, and alarms can be set according to these defined values. The desired range of antimicrobial levels can also be represented stoichiometrically as a ratio of various chemical substances, for example. In this way, the real-time levels of antimicrobial agent in the water supply can be monitored, adjusted, recorded, and verified before irrigation water reaches the field. In the example of FIG. 2, amperometric sensor 208 is positioned before the first water outlet or sprinkler, although other/additional locations can be used. The amperometric sensor 208 can release sampled water into a drain or tank, for example.

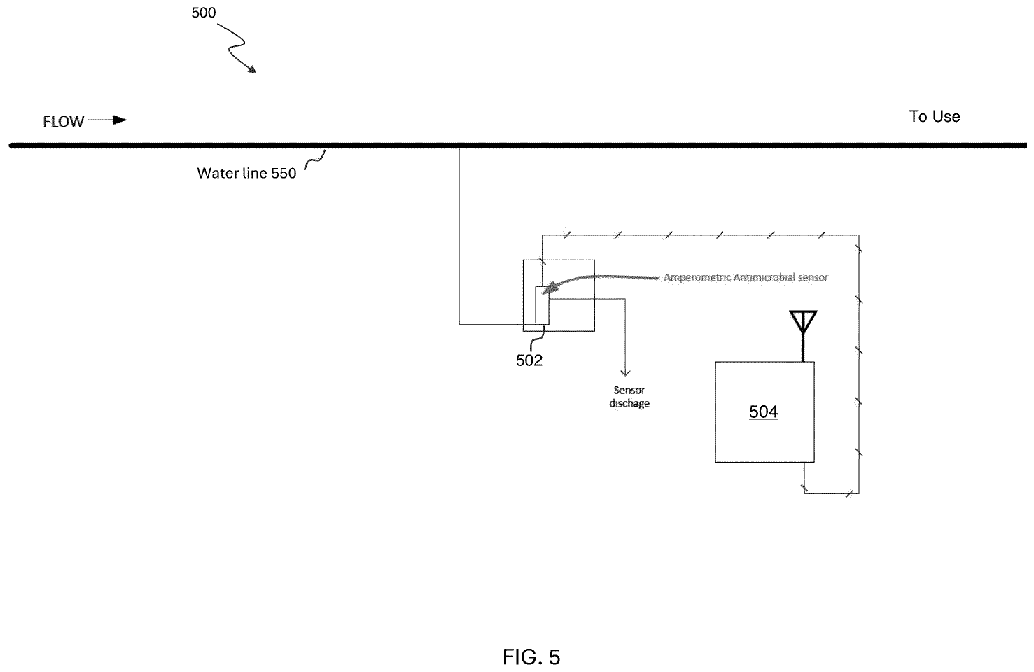

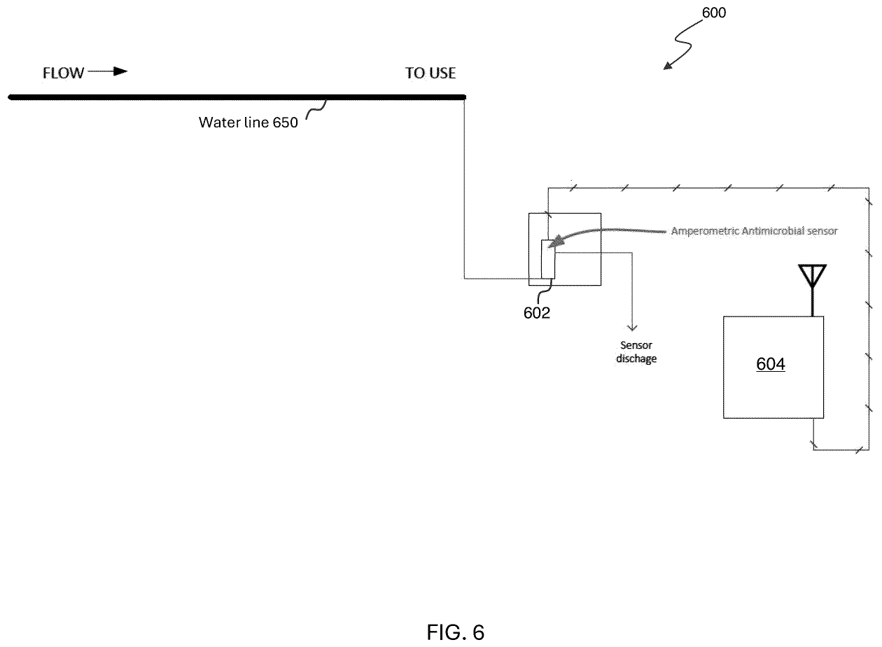

Control unit 206 is communicatively coupled to the dosing pump 202 and amperometric sensor 208 over a wired and/or wireless connection. For example, the wired connection can be USB or Ethernet, for example, or a standard industrial connection using M8 or M12 industrial connections. The wireless connection can be provided by Bluetooth, BLE, 5G, etc. Using the wired or wireless connection, control unit 206 can receive measurement data from amperometric sensor 208, and can send control signals and/or other data to dosing pump 202. Typically the communication between devices is two-way (duplex) communication where devices can both send and receive data. According to some embodiments, the control unit 206 includes an antenna to boost the range and reliability of communication between devices. According to some embodiments, control unit 206 communicates wireless with additional sensors coupled to remote control units (depicted in FIGS. 5-6) disposed at various locations of the irrigation system (e.g., near the last sprinkler at the end of the irrigation system).

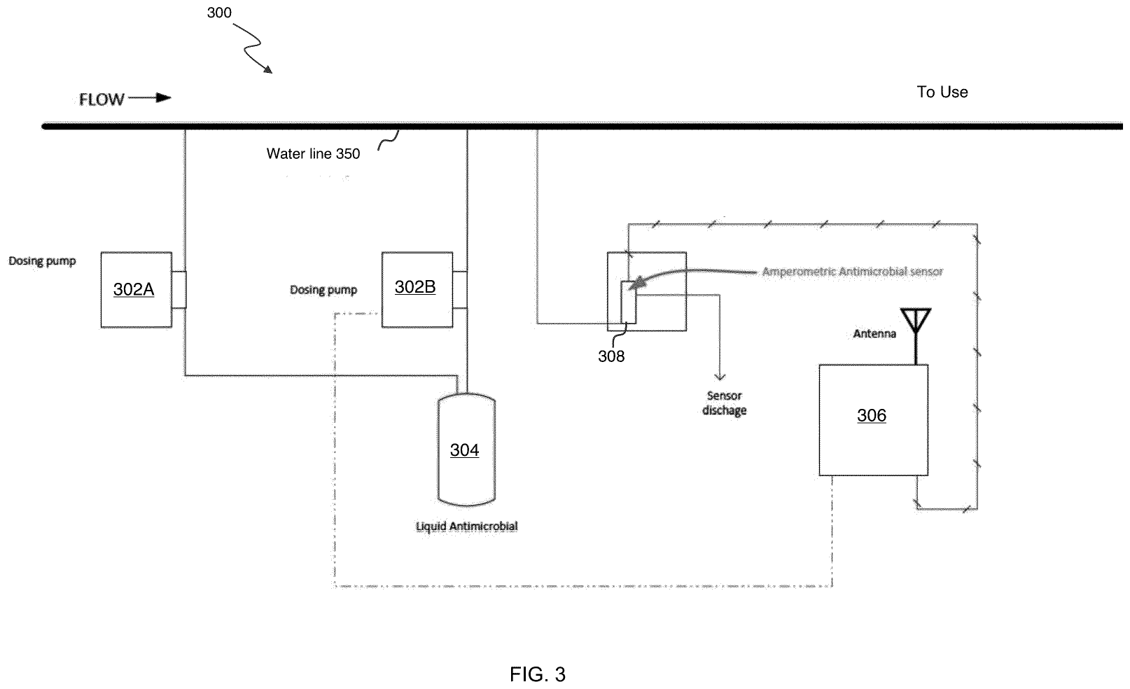

FIG. 3 is a diagram depicting an exemplary automatic antimicrobial treatment and validation system 300 including a two dosing pumps 302A, 302B according to embodiments of the present invention. Similar to the embodiment of FIG. 2, automatic antimicrobial treatment and validation system 300 is a base treatment station disposed near a main irrigation line 350. The operations of dosing pumps 302A, 302B are controlled by control unit 306 to automatically release antimicrobial agents from liquid antimicrobial storage tank 304 into main irrigation line 350 to bring the level of antimicrobial agent in the water flowing through main irrigation line 350 to a specific level or within a specific range of acceptable values.

In the example of FIG. 3, each dosing pump can be configured individually to perform a specific function under the control of control unit 306. For example, dosing pump 302A can be configured as a main dosing pump that releases a relatively large, fixed amount of antimicrobial agent periodically, and dosing pump 302B can be configured to supplement the water supply with a variable, relatively small dosage determined according to readings of amperometric sensor 308. Alternatively, pumps 302A and 302B can serve the same function, where one pump serves as a backup or redundancy in case of failure. According to other embodiments, pumps 302A, 302B operate according to different schedules and/or sensor readings to supply different levels of antimicrobial agent to the water supply. In the example of FIG. 3, pumps 302A and 302B are connected to a common antimicrobial agent supply tank 304, although separate tanks can be used according to embodiments.

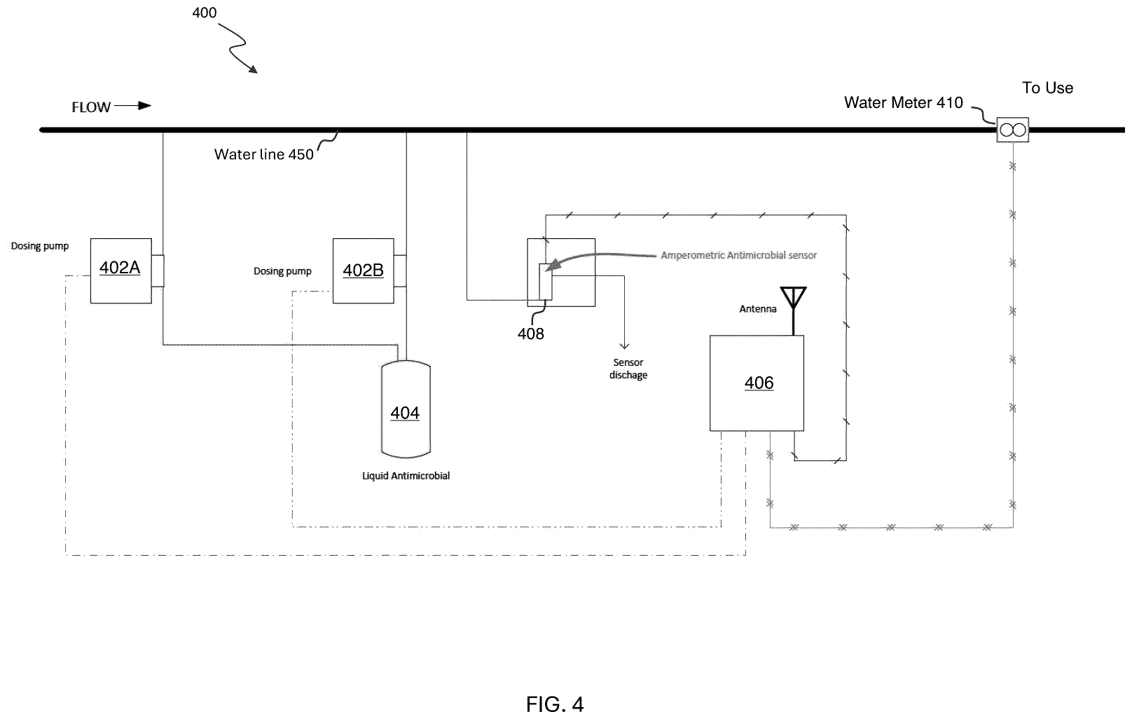

FIG. 4 is a diagram depicting an exemplary automatic antimicrobial treatment and validation system 400 including two dosing pumps 402A, 402B, and a water meter 410 according to embodiments of the present invention. Similar to the embodiment of FIG. 3, automatic antimicrobial treatment and validation system 400 is a base treatment station disposed near a main irrigation line 450, and the operations of dosing pumps 402A, 402B are controlled by control unit 406 to automatically release antimicrobial agents from liquid antimicrobial storage tank 404 into main irrigation line 450 to bring the level of antimicrobial agent in the water flowing through main irrigation line 450 to a specific level or within a specific range of acceptable values. Additionally, antimicrobial treatment and validation system 400 includes a water meter 410 that continuously measures and reports the real-time flow rate of water line 450 to control unit 406. Typically control unit 406, water meter 410, dosing pumps 402A, 402B, and amperometric sensor 408 communicate over a hard-wired connection, although some embodiments may include wireless sensors, for example.

In the example of FIG. 4, one dosing pump can be controlled according to readings of the amperometric sensor 408, and the other dosing pump can be controlled according to the water flow rate. For example, pump 402A can be controlled by control unit 406 to release a substantially continuous dose of antimicrobial agent at a frequency proportionate to the water flow rate determined by water meter 410, and pump 402B can be controlled by control unit 406 to release a periodic dose of antimicrobial agent based on the measured residual determined by control unit 406 (e.g., according to the measurements of amperometric sensor 408). In this way, the antimicrobial levels present in the irrigation water supply (residual) can be maintained within a desired range and recorded over time for field validation.

As mentioned earlier, additional amperometric sensors 408 can be disposed throughout the irrigation system, for example to measure antimicrobial levels (residual) at different points in the system. According to some embodiments, an end-of-the-line amperometric sensor 408 is disposed after the last outlet or sprinkler in the irrigation system to read antimicrobial levels after the last outlet or sprinkler to validate that the amount of residual antimicrobial agent at the end of the irrigation system is within the desired range. The additional amperometric sensors 408 typically communicate wirelessly with control unit 406, which can control one or more dosing pumps 402A, 402B according to the readings of the amperometric sensors 408.

FIG. 5 is a diagram depicting an exemplary remote sensor 500 of an automatic antimicrobial treatment and validation system disposed at an intermediate point of a water line 550 of an irrigation system according to embodiments of the present invention. Remote sensor 500 can include an amperometric sensor 502 or other sensor that measures levels of PAA, chlorine, etc. Remote sensor 502 can communicate over a wired or wireless connection with a sensor communication unit 504 which acts as a gateway to enable remote sensor 502 to communicate with a control unit of a base treatment station (e.g., control unit 406 depicted in FIG. 4). Accordingly, the readings of remote sensor 502 can be analyzed by the control unit of the base treatment station, and the base treatment station can validate the residual amount of antimicrobial agent or adjust the amount of antimicrobial agent supplied by one or more pumps according to the readings of remote sensor 502 via sensor communication unit 504. As discussed, the reported amounts of agent can be recorded. As discussed, the reported amounts of agent can be recorded over time for field validation, e.g., certification.

FIG. 6 is a diagram depicting an exemplary remote sensor of an automatic antimicrobial treatment and validation system disposed at the end of a water line 650 according to embodiments of the present invention. Similar to the embodiment of FIG. 5, remote sensor 600 can include an amperometric sensor 602 or other sensor that measures real-time levels of PAA, chlorine, etc. Remote sensor 602 can communicate over a wired or wireless connection with a sensor communication unit 604 which acts as a gateway to enable remote sensor 602 to communicate with a control unit of a base treatment station (e.g., control unit 406 depicted in FIG. 4). Accordingly, the readings of remote sensor 602 can be analyzed by the control unit of the base treatment station, and the base treatment station can validate the residual amount of antimicrobial agent or adjust the amount of antimicrobial agent supplied by one or more pumps according to the readings of remote sensor 602 via sensor communication unit 604. According to some embodiments, end-of-the-line sensor 600 is used to validate antimicrobial residuals at the end of the irrigation system (e.g., near the last sprinkler or outlet of the irrigation system).

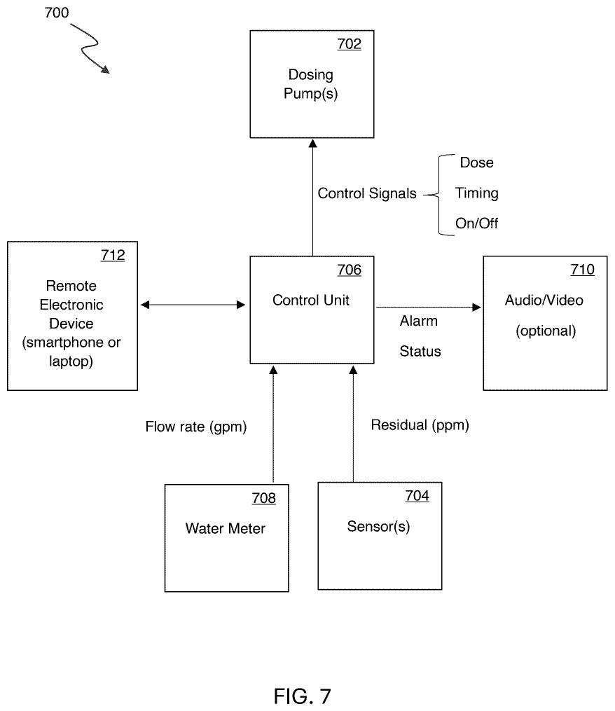

FIG. 7 is a data flow diagram depicting the commands and data communicated between exemplary devices of an automatic antimicrobial water treatment system 700. In the example of FIG. 7, control unit 706 communicates with one or more dosing pumps 702, water meter 708, one or more sensors 704, and optionally with remote electronic device 712, which can be a smartphone, laptop, tablet, desktop computer, etc. The control unit can automatically control the function (e.g., output and timing) of dosing pumps 702 according to various factors, such as amperometric sensor readings and flow rate. According to some embodiments, control unit 706 communicates with the dosing pumps wirelessly using wireless control signals or pulses. For example, the control signals can be between 4 and 20 mA. System 700 can include a memory unit to record measured sensor readings.

Sensors 704 can include multiple sensors disposed at various water lines of an irrigation system. For example, the sensors can be disposed at a midpoint or end-of-line of an irrigation line. The sensors can indicate the amount of antimicrobial agent downstream from the base treatment system to determine initial levels, and can indicate the amount of residual near the last sprinkler or outlet to determine antimicrobial content at the end of the line extending from the base treatment station. These measurements can be used to automatically control pumps 702 so that the measured residual falls within the configured range, and to validate the amount of residual present at the end of the line. According to some embodiments, one or more of pumps 702 are controlled according to measurements of water meter 708 indicating the flow rate of the water line. Generally more antimicrobial agent is required when the flow rate measured by water meter 708 increases. Control unit 706 can also transmit timing or scheduling information for controlling pumps 702 (e.g., on/off hours), and can also manually activate or deactivate the pumps 702.

According to some embodiments, control unit 706 can output audio and/or video data through a speaker of connected device (e.g., a display device). The audio can include an audible alarm that is triggered by control unit 706 when the level of antimicrobial agent measured by sensors 704 falls outside of a predetermined range, or when the flow rate measured by water meter 708 falls outside of a predetermined range. The video data can include status information of the water meter 708, sensors 704, or dosing pumps 702, in the form of text, charts, images, etc.

According to some embodiments, control unit 706 can communicate with a remote electronic device 712 over a local network (e.g., Wi-Fi or Bluetooth) or via the Internet. The device 712 can receive data from control unit 706 for display or can be used to transmit control information to control unit 706, for example, to control dosing pumps, including setting limits, scheduling, manual controls (e.g., on/off), or desired residual values. Electronic device 712 can also record reported sensor readings.

### Exemplary Computer Controlled System

Embodiments of the present invention provide systems and device for performing automatic antimicrobial treatment of irrigation water by controlling one or more antimicrobial pumps according to senor data (e.g., amperometric sensors, water meters, etc.). The following discussion describes one such exemplary electronic system or computer system can be used as a platform for implementing embodiments of the present invention.

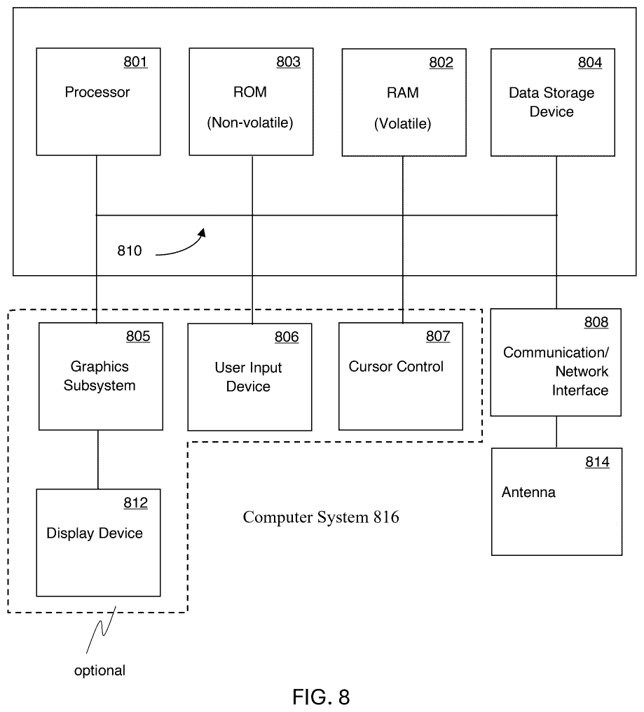

In the example of FIG. 8, the exemplary computer system 816, which can be a control unit such as a base control unit or a remote control unit, includes a central processing unit (CPU) 801 for running software applications and optionally an operating system. Random access memory 802 and read-only memory 803 store applications and data for use by the CPU 801. Data storage device 804 provides non-volatile storage for applications and data and may include network attached storage (NAS) devices, cloud storage devices, fixed disk drives, removable disk drives, flash memory devices, and CD-ROM, DVD-ROM or other optical storage devices. The data storage device 804 or the memory 802/803 can store configuration data for controlling one or more pumps, sensors, etc., and can store and accumulate historic sensor data and pump control data which can be later reviewed, processed, and analyzed to improve performance of the antimicrobial treatment system.

The optional user inputs 806 and 807 comprise devices that communicate inputs from one or more users to the computer system 812 (e.g., mice, joysticks, cameras, touchscreens, and/or microphones). The input devices 806 and 807 can be used to input a desired antimicrobial residual level or range of acceptable values, for example.

A communication or network interface 808 can include one or more radios coupled to an antenna 814 and allows the computer system 816 to communicate with other computer systems, networks, or devices via an electronic communications network, including wired and/or wireless communication and including an Intranet or the Internet. The network interface 808 can retrieve updates stored by a remote computer system or network (e.g., software updates, firmware updates, etc.).

The optional display device 812 may be any device capable of displaying visual information, e.g., the final scan report, in response to a signal from the computer system 816 and may include a flat panel touch sensitive display, for example. The components of the computer system 816, including the CPU 801, memory 802/803, data storage 804, user input devices 806, and graphics subsystem 805 may be coupled via one or more data buses 810. Memory units of system 816 can record reported sensor readings for field validation.

Embodiments of the present invention are thus described. While the present invention has been described in particular embodiments, it should be appreciated that the present invention should not be construed as limited by such embodiments, but rather construed according to the following claims.

What is claimed is:

1. An irrigation system, comprising:
a water line;
a control unit comprising a network interface;
a first dosing pump coupled to the water line, wherein the first dosing pump is operable to release an antimicrobial agent into water flowing through the water line; and
a sensor coupled to the water line and operable to measure an antimicrobial residual of the water flowing through the water line, wherein the sensor is disposed at a downstream location of the first dosing pump, and wherein the control unit is operable to:
receive sensor data from the sensor indicating the antimicrobial residual at the downstream location via the network interface; and
transmit control signals to the first dosing pump to control a function of the first dosing pump based on the sensor data via the network interface.

2. The irrigation system of claim 1, wherein the control unit is further operable to transmit control signals to the first dosing pump based on the sensor data to maintain the antimicrobial residual substantially within a predefined range.

3. The irrigation system of claim 2, wherein the control unit is further operable to trigger an alarm when the antimicrobial residual measured by the sensor is not substantially within the predefined range.

4. The irrigation system of claim 2, wherein the control unit is further operable to adjust the function of the first dosing pump when the antimicrobial residual measured by the sensor is not substantially within the predefined range.

5. The irrigation system of claim 2, further comprising a second dosing pump, and wherein the control unit is further operable to adjust a function of the second dosing pump based on the sensor data.

6. The irrigation system of claim 2, further comprising:
a second dosing pump; and
a water meter coupled to the water line, wherein the control unit is further operable to:
receive a water flow rate indicated by the water meter via the network interface; and
adjust a function of the second dosing pump based on the water flow rate.

7. The irrigation system of claim 1, further comprising a first sprinkler coupled to the water line and operable to release water into a field, and wherein the sensor is disposed downstream of the first dosing pump and upstream of the first sprinkler of the irrigation system.

8. The irrigation system of claim 1, further comprising a farthest downstream sprinkler coupled to the water line and operable to release water into a field, wherein the sensor is disposed downstream of the first dosing pump and downstream of a farther downstream sprinkler, wherein the control unit is further operable to validate an antimicrobial level of the irrigation system based on the sensor data.

9. The irrigation system of claim 1, wherein the antimicrobial agent comprises peracetic acid (PAA), and wherein the sensor comprises a PAA amperometric sensor.

10. The irrigation system of claim 1, further comprising:
a secondary water line coupled to the water line; and
a remote sensor coupled to the secondary water line at an intermediate point between a beginning of the secondary water line and an end of the secondary water line, wherein the remote sensor is operable to measure the antimicrobial residual and transmit sensor data to the control unit.

11. The irrigation system of claim 1, further comprising:
a secondary water line coupled to the water line; and
a remote sensor coupled to the secondary water line at an end of the secondary water line, wherein the remote sensor is operable to measure an antimicrobial residual at the end of the secondary water line and to transmit sensor data to the control unit.

12. An antimicrobial treatment system for treating irrigation water, the antimicrobial treatment system comprising:
a control unit operable to transmit control commands to a first dosing pump and a second dosing pump of an irrigation system;
said first dosing pump operable to release a continuous dose of antimicrobial agent into the irrigation water at a given frequency; and
said second dosing pump operable to release a periodic dose of antimicrobial agent into the irrigation water based on real-time sensor data.

13. The antimicrobial treatment system of claim 12, further comprising an amperometric sensor disposed at a downstream location of the first dosing pump and the second dosing pump and operable to measure an antimicrobial residual of the irrigation water at the downstream location, wherein the real-time sensor data is generated by the amperometric sensor.

14. The antimicrobial treatment system of claim 12, further comprising a water meter operable to measure a flow rate of the irrigation water, wherein the control unit is operable to control frequency of the first dosing pump based on the flow rate.

15. The antimicrobial treatment system of claim 12, further comprising a liquid antimicrobial storage tank operable to supply the antimicrobial agent to the first dosing pump and the second dosing pump.

16. The antimicrobial treatment system of claim 12, further comprising a remote amperometric sensor disposed at a downstream location of the first dosing pump and the second dosing pump and operable to validate an antimicrobial residual of the irrigation water at an endpoint of a water line carrying the irrigation water.

17. An apparatus for controlling an antimicrobial water treatment system of an irrigation system, the apparatus comprising:
a processor; and
a memory coupled to the processor operable to store data, wherein the processor is operable to:
receive sensor data from an amperometric sensor operable to indicate an antimicrobial residual measured at the amperometric sensor;
generate a control signal for controlling a dosing pump based on the sensor data; and
transmit the control signal to the dosing pump to control a function of the dosing pump.

18. The apparatus of claim 17, wherein the amperometric sensor is disposed downstream of the dosing pump and at a location upstream of a first sprinkler of the irrigation system.

19. The apparatus of claim 17, wherein the amperometric sensor is disposed downstream of the dosing pump and at a location downstream of a last sprinkler of the irrigation system, wherein the processor is further operable to validate an antimicrobial level of the irrigation system based on the sensor data.

20. The apparatus of claim 17, wherein the control signal is operable to cause the dosing pump to release an antimicrobial agent comprising peracetic acid (PAA), wherein the amperometric sensor comprises a PAA amperometric sensor.
